(19) United States
(12) Patent Application Publication
(10) Pub. No.: US 2005/0184904 A1
(43) Pub. Date: Aug. 25, 2005

(54) Data filtering by a telemetry device for fleet and asset management

(75) Inventors: Laymon Scott Humphries, Clinton, MS (US); Huey-Jiun Ngo, Flowood, MS (US); Jay B. Wadsworth, Brandon, MS (US); Bracey C. Summers, Madison, MS (US); James F. Dement, Brandon, MS (US)

Correspondence Address: MCI, INC, 1133 19TH STREET NW, WASHINGTON, DC, 20036, US

(73) Assignee: MCI, Inc., Ashburn, VA (US)

(21) Appl. No.: 11/113,249

(22) Filed: Apr. 22, 2005

Related U.S. Application Data
(63) Continuation-in-part of application No. 10/758,770, filed on Jan. 16, 2004.
(63) Continuation-in-part of application No. 11/065,913, filed on Feb. 25, 2005.

(51) Int. Cl. G01S 13/00

(52) U.S. Cl. 342/357.07; 342/95; 342/107

(57) ABSTRACT

An approach is provided for tracking a telemetry device over a wireless network. Data, e.g., Global Positioning System (GPS) information, corresponding to the tracking of the device is received. The data is filtered, at the device, for errant information according to one or more filter parameters.

### RELATED APPLICATIONS

The present application is a Continuation-In-Part of U.S. patent application Ser. No. 10/758,770 filed Jan. 16, 2004, entitled “Method and System for Tracking Mobile Telemetry Devices” and a Continuation-In-Part of U.S. patent application Ser. No. 11/065,913 filed Feb. 25, 2005, entitled “Method and Apparatus for Data Filtering in a Tracking System”; the contents of which are hereby incorporated by reference.

### FIELD OF THE INVENTION

The present invention relates to data communications, and more particularly, to tracking mobile telemetry devices for fleet and asset management.

### BACKGROUND OF THE INVENTION

Modern wireless networks, such as paging systems, can readily be configured to offer a variety of telemetry services, notably fleet and asset management. The management of vehicles within a fleet as well as assets involves obtaining information, generally in real-time, about the location and movement of these objects. The fleet manager utilizes this information to maximize use of fleet resources. With the advent of the Global Positioning System (GPS) supported by a constellation of satellites, a vehicle may determine its location with great accuracy and convenience if no obstruction exists between the GPS receiver within the vehicle and the satellites. At times, accuracy can be compromised if the GPS signals are erroneous or distorted. For example, errant GPS signals can convey false movements of the vehicle. That is, the GPS data may indicate that the vehicle is moving, when in fact the vehicle is stationary. Such information detracts from the user experience, in that the fleet manager, for instance, cannot fully rely on a single, immediate data point.

Conventional tracking systems over a wireless network operate in an autonomous GPS environment. Such an autonomous GPS environment has a number of drawbacks that can hinder its effectiveness as a fleet management system. Because the GPS device must obtain all of the ephemeris data from the satellite signals, weak signals can be problematic. A building location or a location in any area that does not have clear view of the satellite constellation can prevent the GPS device from determining its geolocation. Also, cold start acquisition may consume a few seconds to as much as a few minutes, which is a significant delay for the device's ability to log positional information and evaluate its position against pre-configured alert conditions. The vehicles then need to transmit the location information to the wireless network. These transmissions can consume large amounts of bandwidth of the wireless network if the location information is continually transmitted without attention to the polling scheme and the underlying transmission protocol used to transport such data. Further, bad GPS data can contribute to errant detection of the vehicle's position and speed.

Therefore, there is a need for a fleet and asset management system that effectively integrates GPS technology to ensure timely and accurate acquisition of location information. There is also a need to filter data to minimize erroneous tracking of the asset. There is also a need to efficiently utilize precious resources of the wireless network in support of fleet and asset management services.

### SUMMARY OF THE INVENTION

These and other needs are addressed by the present invention, in which an approach for filtering data in support of tracking mobile telemetry devices is provided.

According to one aspect of the present invention, a method for filtering telemetry data is disclosed. The method includes collecting data for monitoring of an asset. The method also includes receiving one or more filter parameters from a tracking system over a wireless network, and filtering the data according to the received filter parameters. Further, the method includes generating a message based on the filtered data, and transmitting the message over the wireless network to the tracking system.

According to another aspect of the present invention, an apparatus for supporting tracking of an asset is disclosed. The apparatus includes an input/output port coupled to the asset and configured to collect data for monitoring of the asset. The apparatus also includes a transceiver configured to receive one or more filter parameters from a tracking system over a wireless network. Further, the apparatus includes a data filtering logic configured to filter the data according to the received filter parameters, wherein a message is generated based on the filtered data. The transceiver transmits the message over the wireless network to the tracking system.

According to yet another aspect of the present invention, an apparatus for tracking an asset is disclosed. The apparatus includes means for receiving data including Global Positioning System (GPS) information corresponding to tracking of the asset coupled to a vehicle. The apparatus also includes means for filtering the data to account for GPS signal errors associated with position and speed. Further, the apparatus includes means for transmitting the filtered data over a wireless network to a remote server.

Still other aspects, features, and advantages of the present invention are readily apparent from the following detailed description, simply by illustrating a number of particular embodiments and implementations, including the best mode contemplated for carrying out the present invention. The present invention is also capable of other and different embodiments, and its several details can be modified in various obvious respects, all without departing from the spirit and scope of the present invention. Accordingly, the drawing and description are to be regarded as illustrative in nature, and not as restrictive.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a diagram of a fleet and asset tracking system capable of performing data filtering, according to an embodiment of the present invention;

FIG. 2 is a diagram of a telemetry device configured to perform data filtering, according to an embodiment of the present invention;

FIG. 3 is a diagram of a Network Operations Center (NOC) in the system of FIG. 1, according to an embodiment of the present invention;

FIG. 4 is a flowchart of a process for movement filtering, according to an embodiment of the present invention;

FIGS. 5A-5C are diagrams showing exemplary scenarios for the movement filtering process of FIG. 4;

FIG. 6 is a flowchart of a process for excessive speed filtering, according to an embodiment of the present invention;

FIG. 7 is a flowchart of a process for erroneous position filtering, according to an embodiment of the present invention;

FIG. 8 is a diagram of the formats of protocol messages used in the system of FIG. 1; and

FIG. 9 is a diagram of a computer system that can be used to implement an embodiment of the present invention.

### DESCRIPTION OF THE PREFERRED EMBODIMENT

An apparatus, method, and software for data filtering in a tracking system are described. In the following description, for the purposes of explanation, numerous specific details are set forth in order to provide a thorough understanding of the present invention. It is apparent, however, to one skilled in the art that the present invention may be practiced without these specific details or with an equivalent arrangement. In other instances, well-known structures and devices are shown in block diagram form in order to avoid unnecessarily obscuring the present invention.

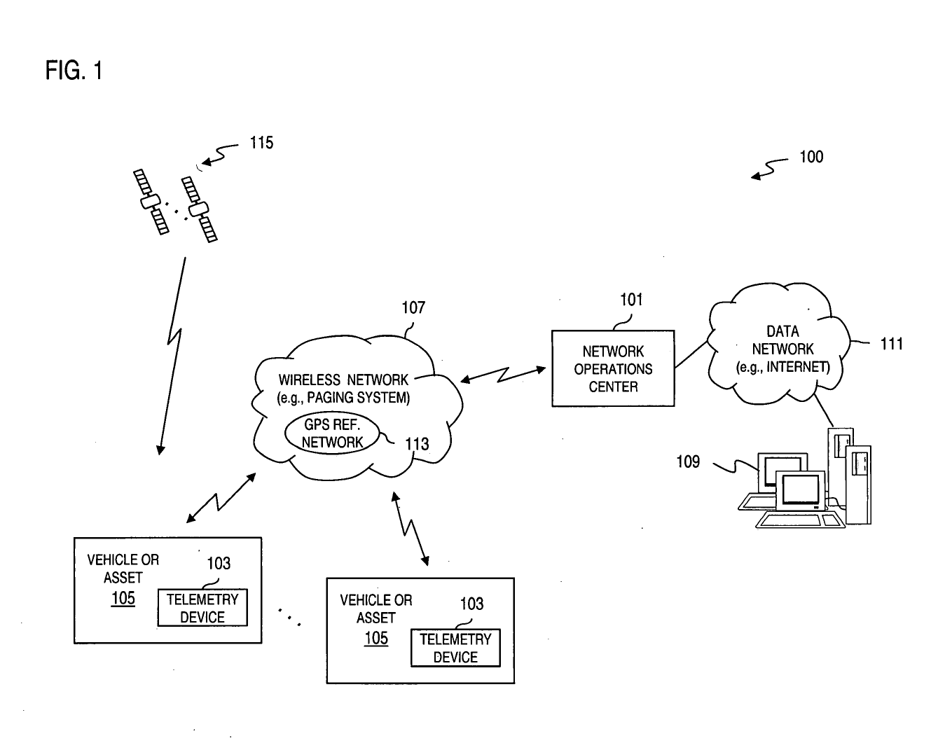

FIG. 1 shows a diagram of a fleet and asset tracking system capable of performing data filtering, according to an embodiment of the present invention. The system 100, in contrast to the conventional wireless tracking system, utilizes a combination of autonomous GPS and Assisted GPS (A-GPS); in particular, mobile-centric A-GPS. The system 100 includes a Network Operation Center (NOC) 101 for tracking telemetry devices 103, which, under this scenario, are resident within vehicles 105. It is contemplated that the telemetry device 103 can be affixed to an asset (or any other object). A wireless network 107 supports two-way communication among the telemetry devices 103 and the NOC 101; the wireless network 107, in an exemplary embodiment, is a two-way paging system employing the ReFLEX™ protocol by Motorola for two-way advanced messaging. According to one embodiment of the present invention, the wireless network 107 provides over the air encrypted messages for secure communication.

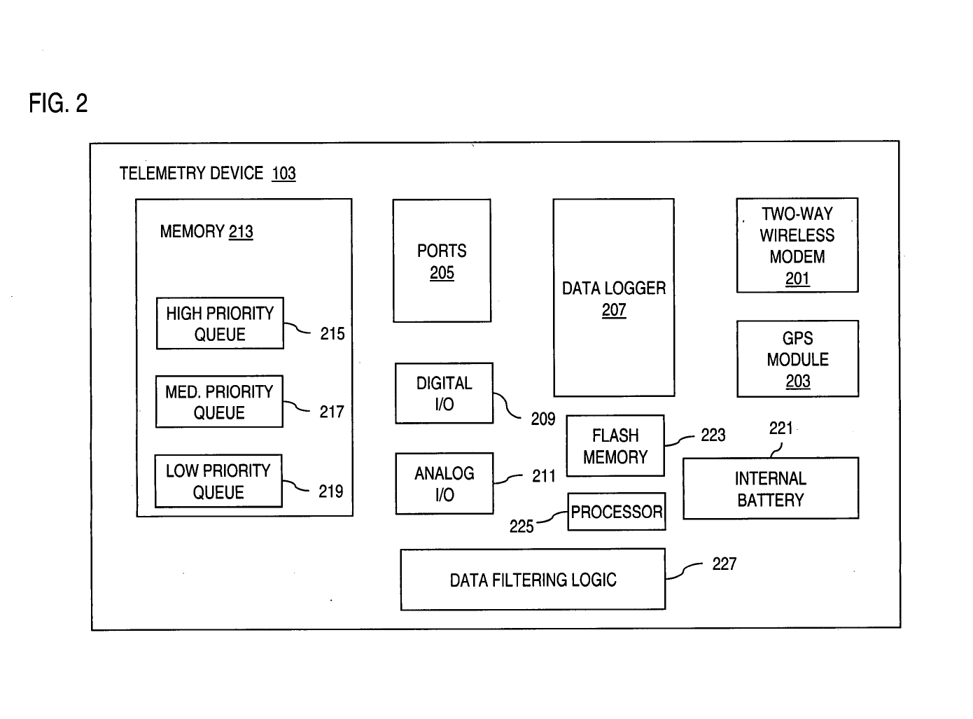

As will be further explained with respect to FIGS. 2 and 4-7, the telemetry devices 103 possess a data filtering capability to minimize transmission of inaccurate or errant data to the NOC 101. This device-based filtering approach advantageously provides efficient use of precious bandwidth within the wireless network 107, in that erroneous data is not transmitted over the air. Another advantage is that the NOC 101 is not burdened by the processing demands associated with data filtering. Further, the user experience is enhanced in that accuracy of the telemetry data is improved.

The telemetry devices 103 have two modes of operation: autonomous GPS mode, and A-GPS mode. When operating in A-GPS mode, the system 100 can provide for better in building or obstructed view geolocation with in a paging system zone. When out of network coverage, the autonomous GPS may be used to obtain geolocation data that may be stored on the device for later transmission.

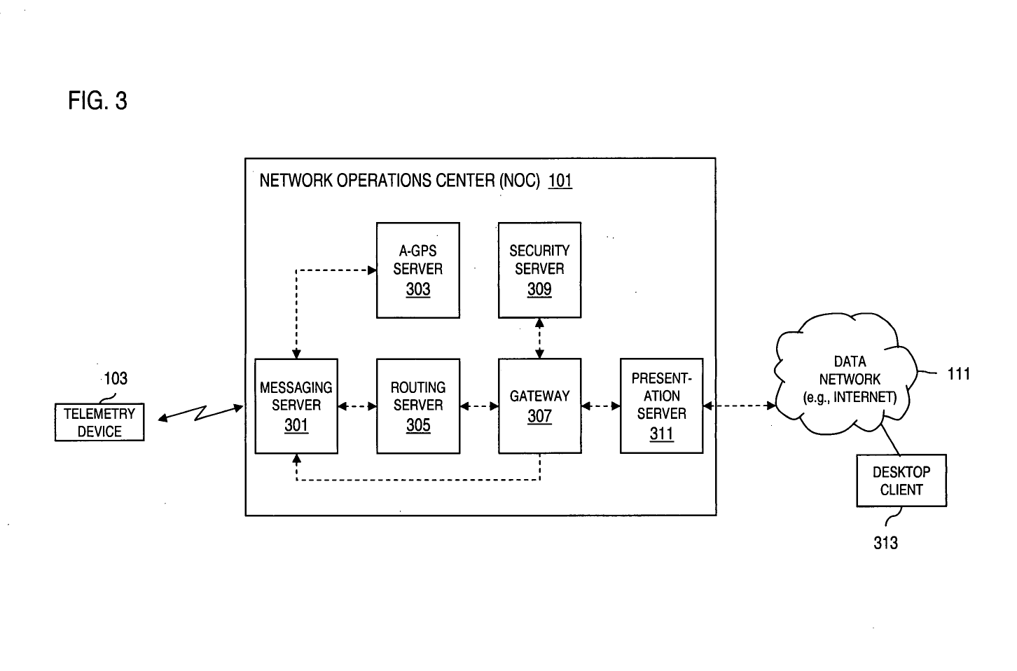

The NOC 101 provides the necessary fleet and asset management functions, such as user account creation and management, access control, and deployment of business rules; these functions are more fully described below with respect to FIG. 3. The NOC 101 also supports remote management capabilities by hosts 109 over a data network 111, such as the global Internet.

To better understand the hybrid A-GPS environment of the system 100, it is instructive to describe the operation of the general operation of a mobile-centric A-GPS system. The telemetry device 103 has GPS hardware and intelligence, whereby the network 107 in conjunction with the NOC 101 employs mechanisms for providing GPS aiding data (or assistance data). The network 107 includes base transmitters and some base receivers containing GPS hardware from which the ephemeris and approximate location can be obtained, constituting a GPS reference network 113. The GPS reference network 113 utilizes multiple GPS satellites 115.

The assistance data that is transmitted to the devices 103, in an exemplary embodiment, can include ephemeris data differential GPS correct data, timing data and/or other aiding data. Using the aiding (or assistance) data, the telemetry devices 103 performs geolocation calculations, yielding a number of advantages. For example, the telemetry devices 103 can generate real-time speed and route adherence alerts. Additionally, transmission of geolocation data need not be frequent. Transmission of geolocation data is more compact because it is true location rather than pseudo range data. Also, the telemetry devices 103 can more intelligently request assistance data because the devices 103 themselves can determine when the ephemeris data is no longer valid.

The hybrid A-GPS system 100 thus permits fast and precise geolocation when in network coverage of the network 107, while providing immunity from obstructed view of the sky. Also, when the switch is made to autonomous GPS mode (when outside of the coverage area of the network 100), the devices 103 can still obtain geolocation data. This data can be stored within the device 103 and transmitted to the NOC 101 when the associated vehicle 105 returns to the network coverage area.

As noted earlier, the telemetry devices 103 may be attached to a host entity such as a vehicle or other valuable asset. The device may be used to track, monitor, and control aspects of the host entity. These devices 103 are configurable with respect to the existence and number of digital inputs/outputs (I/O), analog inputs/outputs (I/O), and device port interfaces for connection with peripheral devices. By way of examples, the digital inputs can be used to monitor various components of the vehicles 105: ignition status, door lock status, generic switch status, headlight status, and seat occupancy status. The digital outputs can be used to control, for example, the starter, and door locks, and to monitor such parameters as engine temperature, cargo temperature, oil pressure, fuel level, ambient temperature, and battery voltage. The exact configuration of the telemetry devices 103 can be based on cost consideration and/or applications.

The telemetry devices 103, in an exemplary embodiment, employ a wireless protocol to receive commands and transmit data and alerts (e.g., high speed alert) over the radio network 107. The telemetry devices 103 can queue alerts, message responses, and scheduled data, whereby if the devices 103 are unable to send the messages, the messages are queued and sent when the device 103 returns to wireless network coverage. Prioritized queues are used and include, for example, queues for high, normal, and low priority messages. In the exemplary implementation, critical device status changes are given highest priority, while other alerts and responses are given normal priority. Scheduled data messages are given the lowest priority. The queues are configured, as first in yields first out, wherein new messages are dropped when its corresponding queue is full. This arrangement advantageously allows for the status of the device 103 at the time of transmission failure to be known even when the data stored in the data log at time of the transmission has been overwritten.

The telemetry devices 103 can also respond to status (e.g., of position, speed, digital I/O port status, analog input channel status, peripheral status or other device status) queries transmitted by the NOC 101. The status query may request either current status or status within a time and date range. The device 103 responds to the query with either the current status or all status within the date and time range that is currently stored in the device's data log.

As regards data logging, the devices 103 support use of one or more schedules for the data acquisition. The data logging involves storing of the data locally on the device 103. This data, which can include position, speed, digital I/O port status, analog input channel status, peripheral status or other device status is not automatically transmitted over the air. Instead, the data is stored for a finite period of time and made available for use by scheduled data acquisitions, data acquisitions on demand, and data acquisitions associated with alerts. The data log is circular in that when the last available memory for the data logger has been written, the data logger begins recording new data at the first location of memory available for the data logger.

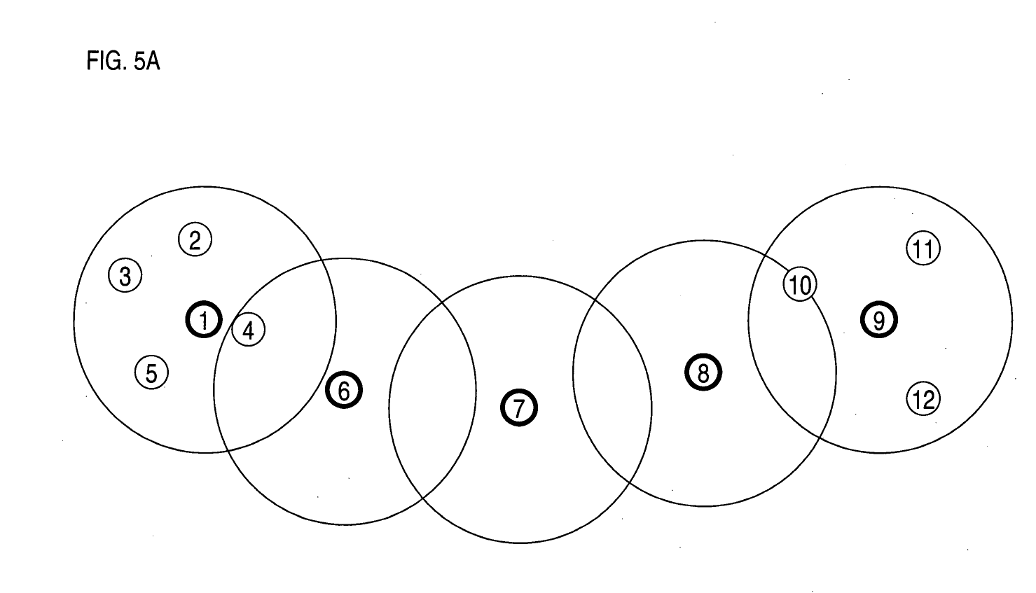

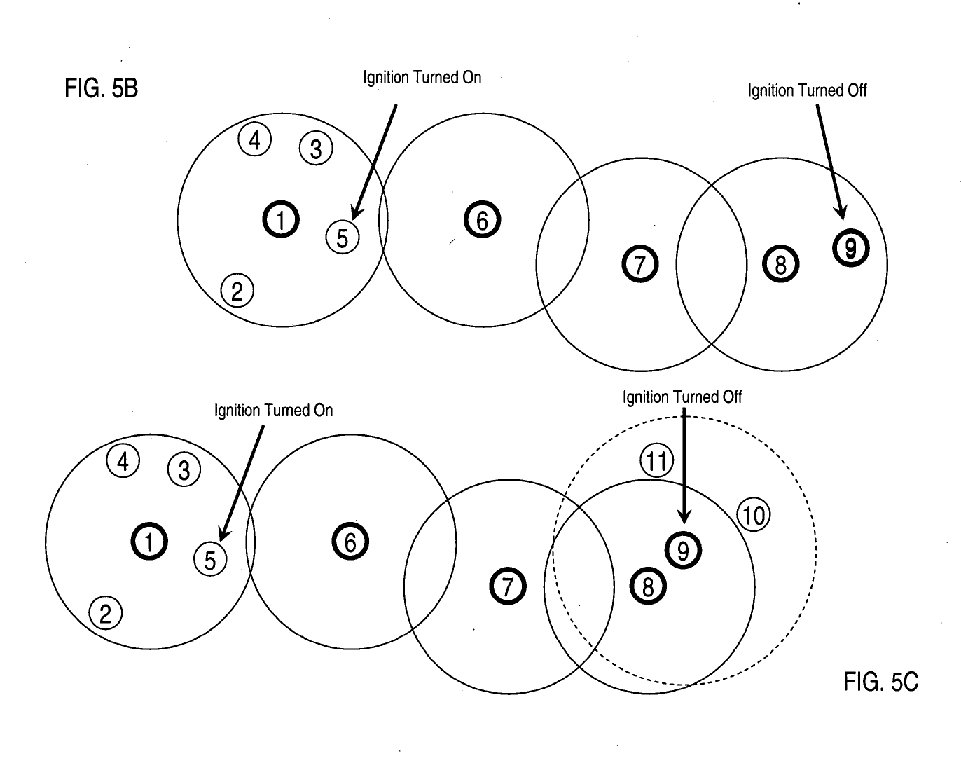

With scheduled acquisitions of the data collected by the data logger, the data within the data log is transmitted by the device 103 according to a configurable schedule at the configured transmission rate. Multiple schedules may be configured on the device 103. Schedules are configured to obtain data at a regular interval based upon calendar time and date. Schedules may be configured such that they are enabled and disabled based upon status of a digital input. For example, an ignition status input may be used to turn a schedule on when the engine is On and turn the schedule off when the engine is Off. A Response (or Data) Message Window value can be configured on the device 103, such that the device 103 delays sending scheduled data using an Offset within the Data Message Window (shown in FIG. 5). That is, the scheduled transmit time is adjusted by the Offset, the device 103 delays queuing the scheduled data until the time is equal to the transmit time plus the Offset. Use of the Data Message Window helps prevent overwhelming the wireless network when many devices are scheduled to transmit data at the same time. For example, it is likely that many schedules will be based upon transmitting on the hour, half past the hour, or at fifteen minute intervals. Using the Offset ensures that the scheduled data transmissions from all of the devices with similar schedules are not sent at precisely the same time. Given the precision of the telemetry device's clock (as it is based upon GPS time), this randomization of regularly scheduled device transmissions is particularly useful.

As mentioned previously, the telemetry devices 103 can be configured to monitor a variety of information relating to the vehicle or asset through the digital I/O and analog I/O. For instance, alerts can be used to indicate status change of the digital inputs. Each Digital Input Status Change Alert can be enabled and disabled through configuration. The alert may be configured to transmit other device status recorded at the time of the alert such as position, speed, status of other digital I/O ports, analog input status, peripheral status, or other device status. As regards the digital output, the status of each available digital output can be changed or read.

Similarly, the statuses of analog inputs of the devices 103 are monitored for change. In an exemplary embodiment, multiple threshold levels (e.g., high and low) can be set, whereby alerts are generated (e.g., Low Range Entry alert, Low Range Exit, High Range Entry, and High Range Exit). That is, if the value of the Analog Input falls below the Low Threshold, a Low Range Entry Alert is generated. If the value of the Analog Input rises above the Low Threshold plus a Hysteresis is value, a Low Range Exit Alert is generated. In similar fashion, if the value of the Analog Input rises above the High Threshold, a High Range Entry Alert is output from the device 103. Also, if the value of the Analog Input falls below the High Threshold minus a Hysteresis value, a High Range Exit Alert is generated. The alert may be configured to transmit other device status recorded at the time of the alert such as position, speed, status of other digital I/O ports, analog input status, peripheral status, or other device status.

By way of example, the devices 103 can be used to monitor excessive speed via a High Speed Alert Control, whereby a High Speed Threshold can be set by a fleet manager. In addition, a duration parameter (i.e., High Speed Duration) can be utilized to specify the time at which the High Speed Threshold must be exceeded before an alert is generated. Further, a configurable High Speed Hysteresis parameter is set as the delta change below the High Speed Threshold used to determine when the High Speed Threshold has no longer been exceeded. The alert may be configured to transmit other device status recorded at the time of the alert such as position, speed, status of other digital I/O ports, analog input status, peripheral status, or other device status.

The system 100 also permits users via the hosts 109 to specify and configure areas of interest within the coverage area of the network 101 such that alerts can be generated when a device 103 enters or exits the configured areas. The alert may be configured to transmit other device status recorded at the time of the alert such as position, speed, status of other digital I/O ports, analog input status, peripheral status, or other device status.

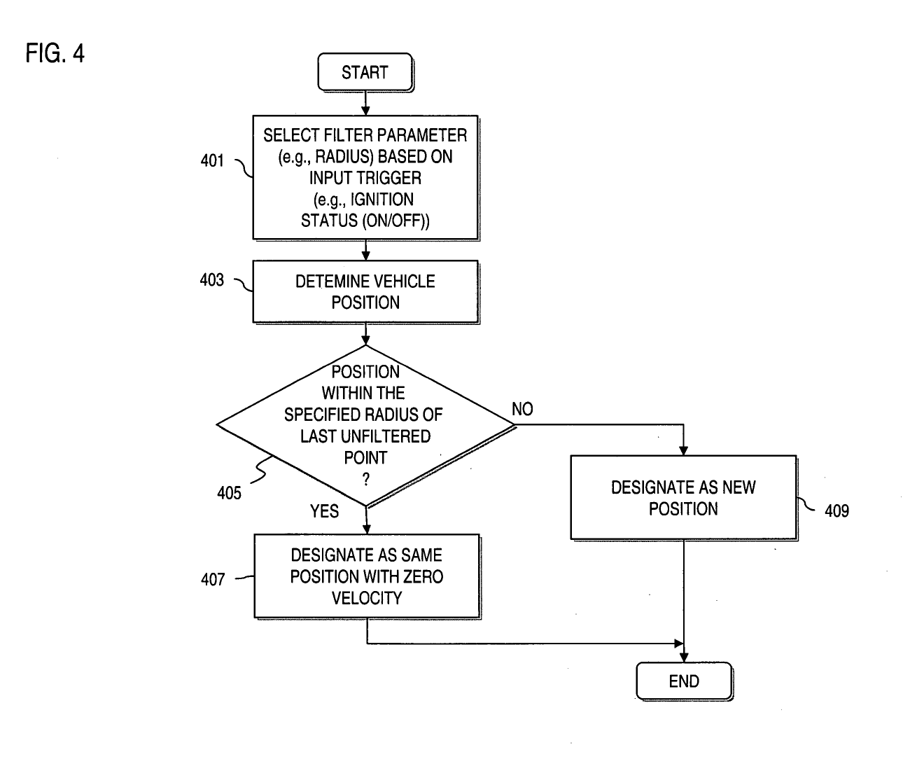

It is recognized that a tremendous amount of data and associated alerts can result. Therefore, filtering such data is useful, particularly if the data is inaccurate. Notably, GPS positional data can be erroneous due to environmental conditions, which can cause errors or distortions of the GPS signal received by the devices 103. For example, small position changes can sometimes be detected on non-moving vehicles, as well as excessive speeds and erroneous positions. Consequently, such errant information is filtered, in an exemplary embodiment, at a gateway within the NOC 101, as more fully described with respect to FIGS. 4-7. The data collected and transmitted by the telemetry devices 103 are processed by the NOC 101, the components of which are described in FIG. 3.

FIG. 2 is a diagram of a telemetry device configured to perform data filtering, according to an embodiment of the present invention. The telemetry device 103, which can be deployed within a vehicle (as shown in FIG. 1 or coupled to any asset), operates within the wireless network 107. By way of example, the components of the telemetry device 103 are described in the context of a narrowband network, such as a paging system; however, it is contemplated that the components for communications can be tailored to the specific wireless network.

In this exemplary embodiment, the telemetry device 103 includes a two-way wireless modem (i.e., transceiver) 201 for receiving and transmitting signals over the wireless network 107 according to the communication protocols supported by the wireless network 107, such as the Motorola ReFLEX™ protocol for two-way paging. By way of example, a Karli ReFLEX™ module by Advantra International can be used for the modem 201. The two-way wireless modem 201 couples to a two-way wireless antenna (not shown) that can be placed local to the device 103 or remote from the device 103 (e.g., 12 or more feet) to enhance flexibility in installation.

The telemetry device 103 also contains a GPS module 203 that is capable of operating in the multiple GPS modes: autonomous GPS mode, and mobile-based A-GPS mode. The GPS module 203 can employ, for example, a GPS receiver manufactured by FastraX—iTrax02/4. In autonomous mode, GPS data may be acquired with no assistance data provided by the wireless network 107. The GPS module 203 operates in the A-GPS mode when the device 103 is in wireless network coverage, in which assistance data is supplied and can include ephemeris data and data to obtain location in obstructed view locations (in building, wooded areas, etc.). Further, the assistance can include differential GPS (DGPS) to enhance location accuracy under some conditions. The GPS module 203 couples to a GPS antenna (not shown) that can be placed local to the device 103 or remote from the device 103 (e.g., 12 or more feet) to enhance flexibility in installation.

Attachment of peripheral modules to the telemetry device 103 are supported by one or more peripheral ports 205. The ports 205, for example, can be used to connect to intelligent peripherals that operate according to business rules and logic. These business rules and logic can be housed in a vehicle harness (not shown), which include an On-Board Diagnostic (OBDII) interface and intelligence. Under this arrangement, a user (e.g., fleet manager) can query any parameter available through the OBDII interface. For example, data obtained for each tracking record can include any combination of the following items: RPM (Revolutions Per Minute), oil pressure, coolant temperature, etc. Such data recorded by the telemetry device 103 is stored in memory 213. The acquisition period for the data is configurable, as well as the transmission interval to the NOC 101. Furthermore, the monitoring and subsequent data exchange can be governed by a configurable schedule, which can specify such parameters as start date, start time, end time, recurrence (e.g., daily, weekly, monthly, etc.), and duration.

Data is logged by a data logger 207, made available for use by scheduled data acquisitions, data acquisitions on demand, and data acquisitions associated with alerts. As mentioned, the telemetry device 103 also can be configured to include digital I/O 209 and analog I/O 211 for monitoring and control of the vehicle or asset. The data logger 207 also collects data associated with these I/O ports 209, 211.

The telemetry device 103 also includes a processor 225 that may handle arithmetic computations, and may support operating system and application processing. The processor 225, while shown as a single block, may be configured as multiple processors, any of which may support multipurpose processing, or which may support a single function.

The memory 213 of the telemetry device 103 can be organized to include multiple queues for prioritizing the messages to be processed by the device 103. In an exemplary embodiment, the memory 213 includes a High Priority queue 215, a Medium Priority queue 217, and Low Priority queue 219. The memory 213, while shown as a single block, may be configured as multiple memory devices, any of which may support static or dynamic storage, and may include code for operating system functionality, microcode, or application code.

Data recorded by the telemetry device 103 may additionally be stored in a storage medium other than the prioritized queues 215, 217, and 219, such as in a flash memory 223. A log (not shown) of information may be kept so that the information may be transmitted according to a schedule, as discussed above, or, e.g., upon receipt of a request to send all data that has been collected. Storage devices have only a finite amount of space for storage of information, and thus the information for only a finite number of messages may be stored in either the prioritized queues 215, 217, 219 or the flash memory 223.

Each of the telemetry devices 103 has a data filtering logic 227, which provides filtering of information collected by the inputs 209, 211. Consequently, the devices 103 avoid or minimize transmitting errant data to the NOC 101. In an exemplary embodiment, three types of filtering are implemented: a minimum movement filter, excessive speed filter, and erroneous point filter. The minimum movement filter yields non-movement of the device (or vehicle) based on a predetermined radial distance threshold, whereby position information outside the radius is considered a valid position change. Also, separate configurable minimum radius filters are utilized depending on a trigger status; e.g., vehicle ignition/engine status, On or Off. The excessive speed filter invalidates speed of the vehicle based, in part, on the number of GPS satellites used to determine the speed and/or the vehicle ignition status. Although the various embodiments are described with respect to “speed,” it is recognized that other parameters in which speed is a component can also be filtered, such as velocity. The erroneous position filter invalidates position of the vehicle based on a determined distance traveled over time interval or the number of GPS satellites and/or the vehicle ignition status. Accordingly, the data filtering logic 227 employ such filter parameters as maximum allowable speed, satellite accuracy threshold, and maximum “bad” position count. The maximum allowable speed parameter specifies the permissible speed of the vehicle. The satellite accuracy threshold indicates the minimum number of satellites required to ensure reasonable accuracy of the GPS signals. The maximum bad position count parameter relates to the number of consecutive detection of an erroneous position of the vehicle. This parameter serves to identify a position problem with the reference point, as to minimize false positives. These exemplary filter parameters are enumerated below in Table 1.

TABLE 1

| Filter Parameters | Description |
|---|---|
| On Trigger Minimum | Radius that must be exceeded before |
| Movement Radius | recognizing movement when Trigger is On. |
| Off Trigger Minimum | Radius that must be exceeded before |
| Movement Radius | recognizing movement when Trigger is Off. |
| On Trigger Maximum | This parameter is used to validate consecutive |
| Derived Speed | positions by limiting the speed derived from the |
| | two positions and interval of time between them |
| | when Trigger is On. |
| Off Trigger Maximum | This parameter is used to validate consecutive |
| Derived Speed | positions by limiting the speed derived from the |
| | two positions and interval of time between them |
| | when Trigger is Off. |
| Maximum Movement | Distance per unit time |
| Threshold | |
| Satellite Accuracy | Defines a threshold at which the probability of a |
| Threshold | bad position fix is significant if paired with |
| | position data. |
| Maximum Allowable | Maximum speed allowable. If a speed above |
| Speed | this value is detected during a GPS read, the |
| | speed is deemed invalid. Any alerts resulting |
| | from an invalid speed are discarded. |
| Maximum Bad | Maximum number of consecutive bad positions |
| Position Count | allowed. |
| Disable High Speed | Disable High Speed Alerts when The Trigger is |
| Alert | Off. |

The above filter parameters can be configured by the customer via, for example, the desktop client. The NOC 101 can receive a filter configuration request by the desktop client (which can be an enterprise host) for specifying the parameters for these filters.

To improve availability of the telemetry device 103, an internal battery 221 is optionally included. With the internal battery, the telemetry device 103 can continue to monitor and transmit alerts and status information to the NOC 101 even if the electrical system of a vehicle is inoperable. Additionally, the internal battery 221 can be used by the device 103 to gracefully report power status wirelessly and shut down gracefully when the energy level of the internal battery is becoming to low to sustain operation of the device

The functions of the NOC 101, which interacts with the telemetry devices 103 to exchange information for supporting fleet and asset management, are detailed with respect to FIG. 3.

FIG. 3 shows a diagram of a Network Operations Center (NOC) in the system of FIG. 1, according to an embodiment of the present invention. The NOC 101 utilizes, in this exemplary embodiment, a client-server architecture to support the telemetry devices 103. Specifically, the NOC 101 houses a messaging server 301 for sending and receiving messages to the devices 103 over the air, for storing the messages, and routing these messages to their destination. The NOC-101 provides connectivity via a local area network (LAN) (not shown) for the messaging server 301 with an A-GPS server 303, a routing server 305, and a gateway 307. The gateway 307 communicates a with a security server 309 to support encryption and decryption of the messages. A presentation server 311 resides within the NOC 101 to interface with the data network 111 (e.g., the global Internet), such that the host 109 can access the services of the fleet and asset management system. The host 109 under this scenario is loaded with a desktop client 313.

Although a single server is shown for the presentation server 311, in the alternative, the server 311 can functionally be implemented as three separate servers: a database server, a middleware server, and a web server. The database server is responsible for data storing, data updating, and data retrieval as well as providing a set of interfaces to achieve these functions. The web server is responsible for serving maps, presenting user interfaces to manage and control user administration, device configuration, and etc. The middleware server can be deployed between the database server and the web server, and has the following responsibilities: 1) converting the web server's data retrieval requests to database server APIs and then sending to database server, 2) receiving the responses from the database server and then sending back to web server, 3) receiving data from gateway 307 and then sending requests to the database to store/update data records. Because of the modularity in this design, these three components can reside on the same machine, as shown in FIG. 3, or reside in multiple platforms.

Messages from the telemetry devices 103 are forwarded by the messaging server 301 to either the A-GPS server 303 or the routing server 305. If the message is an assist request, this message is sent to the A-GPS server 303. In response to the GPS assist request, the A-GPS server 303 determines GPS assistance data for transmission to the requesting telemetry device 103.

The A-GPS server 303 obtains ephemeris data from the GPS reference network 113, and determines satellite configuration for each of the geographic zones comprising the wireless network. The A-GPS server 303 also determines the assistance data for each geographic zone. The NOC 101 then periodically broadcasts the assistance data to each geographic zone. In addition, the A-GPS server 303 supplies GPS assistance data to any telemetry device 103 that requests the GPS assistance data. When supporting this request, the NOC 101 determines approximate location of the requesting device 103 (based upon base receivers that received the request, using a type of triangulation. Subsequently, a GPS Assistance message is generated by the A-GPS server 303 to send to the telemetry device 103 based upon its approximate location. The messaging server 301 sends the GPS Assistance message to the particular telemetry device 103.

Thus, the A-GPS server 303 delivers GPS assistance data through two mechanisms by periodically broadcasting GPS assistance data to all devices 103 in each of the geographic zones covered by the wireless network 107, or by responding to specific requests by the telemetry devices 103 for GPS assistance data.

The routing server 305 has responsibility for routing of the messages from the telemetry devices 103, and managing such messages from the devices 103 to their server destinations. Each device 103 can be configured to have messages directed to one or more destination servers. The routing server 305, upon receiving message from a telemetry device 103, determines a destination address that has been configured for the device 103 and modifies the destination address accordingly. The message is then forwarded to the configured destination. By default, the messages are directed to the gateway 307.

The gateway 307 interfaces with the presentation server 311 to permit the desktop client 313 access to the fleet and asset management system. The gateway 307 provides translation of wireline messages and commands from the presentation server 311 to the wireless protocol for communication with the telemetry devices 103. For example, the gateway 307 supports an eXtensible Markup Language (XML) interface, such that XML commands submitted to the gateway 307 over wireline are converted to the wireless protocol commands and sent over the paging network 107 to the devices 103. In turn, the wireless protocol messages received from the devices 103 are converted to wireline XML messages. The gateway 307 provides translation of wireline messages and commands from the host 109 to the wireless protocol for communication with the telemetry devices 103. In turn, the wireless protocol messages received from the devices 103 are converted to wireline XML messages and sent to host 109.

The presentation server 311 provides the following functions: fleet and asset tracking, and general purpose I/O monitoring and control. The server 311 also maintains a database (not shown) for user accounts and other related data (e.g., configuration data, user management information, device management, and data acquired from the devices 103). The presentation server 311, as mentioned, also generates the maps corresponding to where the devices 103 are tracked and the mapping preferences configured. Using the desktop client 313, a user can even issue requests to command a particular device 103, such as requesting location of the device 103.

With the presentation server 311 as a front end, a user via the desktop client 313 can configure the telemetry devices 103 via web interfaces. In an exemplary embodiment, the server 311 is a World Wide Web (“web”) application server to support a web browser based front-end for the desktop clients 109. The web application server (not shown) can be deployed to support such web interfaces as a set of Java Server Pages (JSP) and Java Applet to interact with the user on the desktop client 313. On the backend, based on data collected by JSP and Java Applet, the web server can generate the proper XML commands that are compliant with Application Programming Interface (API) of the presentation server 311. Consequently, the collected records can be stored in the database of the presentation server 311. The database also stores the properties of the telemetry devices 103, such as the alerts and thresholds earlier described.

The desktop client 313 interfaces to the system 100 through the presentation server 311. From the desktop client 313, the user logs in to the system 100. The presentation server 311 can also perform authentication as well as administration tasks such as adding new users or devices 103. The user can also configure business rules executed by the presentation server 311, wherein the business rules logic uses this user supplied configuration to configure the devices 103, acquire, and process data from the devices 103.

Additionally, the presentation server 311 provides a reporting capability based on the stored information in the database. The presentation server 311 can support standard reports or customize reports to the user via the desktop client 313.

Instead of using a desktop client 313, the user, if associated with a large organization, can utilize an enterprise server to obtain all of the user functionality through the gateway 307 using the API of the fleet and asset management system 100. Accordingly, the enterprise server would possess the functional capabilities of the presentation server 311, but would be managed by the customer (or user) at the customer's premise.

As noted, the wireless protocol supports communications between the NOC 101 and the telemetry devices 103. In an exemplary embodiment, the messaging is performed according the FLEXsuite Uniform Addressing & Routing (UAR) protocol (developed by Motorola). The wireless protocol message, which can be encapsulated with an UAR message, is unencrypted.

FIG. 4 is a flowchart of a process for movement filtering, according to an embodiment of the present invention. The minimum movement filter is used to eliminate the appearance of small movements when a vehicle is parked or stationary due to errors in the GPS signal received by the device 103. In other words, this filter is used to filter out small changes in GPS coordinates that are typically seen when a device is not moving. Causes of the small “false” movements can be due to signal and timing errors that may be caused by atmospheric conditions, obstructions, reflected GPS signals, etc. These errors are typically minor, and may be filtered out by requiring changes in position to meet a minimum distance (e.g., radius) criterion.

The filtering process provides the ability to specify a filter radius for when the vehicle ignition is On, and second filter radius when the vehicle ignition is Off. Two typical non-moving conditions exist. In one scenario, a vehicle is parked with the ignition/engine Off. In a second scenario, the vehicle is stopped in traffic, at a stoplight, at a stop sign, etc., with the ignition/engine On. When the ignition is Off, the minimum distance may be set to a larger value than when the ignition On, since no movement is expected, thereby allowing for stronger filtering. As a result, the filter parameters are defined to allow for different filtering criteria for the ignition On and ignition Off conditions. It is contemplated that this notion of On/Off triggering can be used in other applications other than ignition status. Accordingly, an input trigger is defined, which in this example, is the ignition status.

In step 401, a filter parameter (e.g., filter radius) is selected based on whether the ignition status of the vehicle, which is coupled to the device 103. The position of the vehicle is determined, per step 403. Next, the process determines whether the position of the vehicle is within the specified radius of the last unfiltered point (i.e., last valid position), as in step 405. If the position is within the radius, the position is declared to be the same position as the last unfiltered point (step 407). In addition, the process declares zero velocity for the vehicle. Otherwise, a change is position is noted, as in step 409.

The above process is further illustrated in the examples of FIGS. 5A-5C.

FIGS. 5A-5C are diagrams showing exemplary scenarios for the movement filtering process of FIG. 4. In FIG. 5A, a sequence of GPS samples (e.g., two points) is collected by the device 103 at the data logging sample rate. Each bolded point is recorded as a “New Position,” enclosed in a larger circle with radius set to the Minimum Movement Radius. Each unbolded point without a concentric circle is considered a “No Change Position.”

In this example, Position 1 is stored and flagged as a “New Position.” Since Positions 2 through 5 remain within the Minimum Movement Radius, they are flagged as “No Change Positions.” However, Position 6 is outside of the Minimum Movement Radius, and is thus flagged as a “New Position.” Likewise, subsequent points 8 through 9 are also flagged as “New Positions.” Positions 10 through 12 are flagged as “No Change Positions” since they fall with the Minimum Movement Radius of Position 9.

The scenario of FIG. 5B involves Trigger On/Off transitions (e.g., ignition turning Off). As previously discussed, the minimum movement filtering process can utilize separate filters: one radius filter when an input trigger (e.g., ignition) is On, and another radius filter is applied when the input trigger is Off. The Ignition is Off (Trigger Off) when point one is recorded as a “New Position.” With Trigger Off, the Minimum Movement Radius is set to the Off Trigger MinimumMovement Radius. As with the first point, Points 2 through 4 are flagged as “No Change Positions.” At Position 5, Ignition is turned On (Trigger On).

Because Position 5 remains within the Minimum Movement Radius of Position 1, it is considered a “No Change Position.” However, if an alert is generated, Position 5 will be reported. The change to Ignition On, however, does change the Minimum Movement Radius from Off Trigger Minimum Movement Radius to On Trigger Minimum Movement Radius, and thus, the movement will be evaluated using this new filter.

Position 6 becomes the next “New Position”, followed by Positions 7 and 8. At Position 9, the Ignition is turned Off and is considered a “New Position.” Even though Position 9 falls within the Minimum Movement Radius, because of the state change it is considered a new position. At Position 9, the Minimum Movement Radius is set to Off Trigger Minimum Movement Radius. According to this new radius, Positions 10 and 11 are “No Change Positions,” as seen in FIG. 5C.

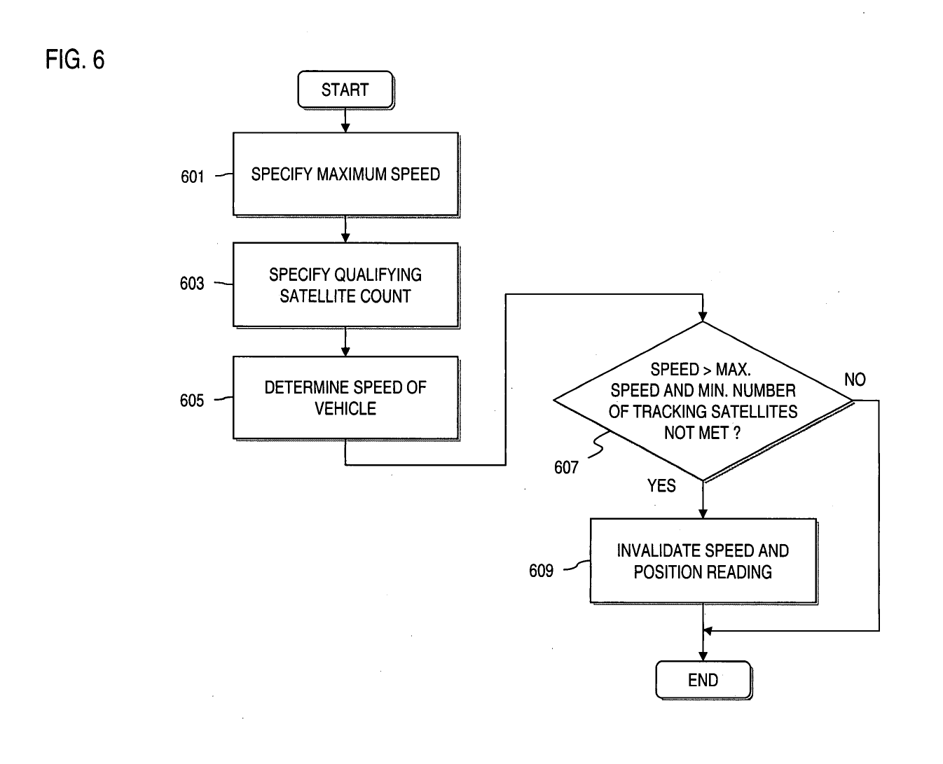

FIG. 6 is a flowchart of a process for excessive speed filtering, according to an embodiment of the present invention. The device data filtering logic 227 also provides excessive speed filtering to filter errant speed data that occur when a small (or insufficient) number of GPS satellites are being tracked or when GPS signal errors corrupt the speed measurement. A maximum speed is specified along with a qualifying satellite count, per steps 601 and 603. In step 605, the speed of the vehicle is determined. If the maximum speed is exceeded and the minimum number of tracking satellites is not met, both the speed and position reading are invalidated (steps 607 and 609). Further, in one embodiment of the present invention, speed filtering is possible by disabling speed alerts when a vehicles ignition is Off.

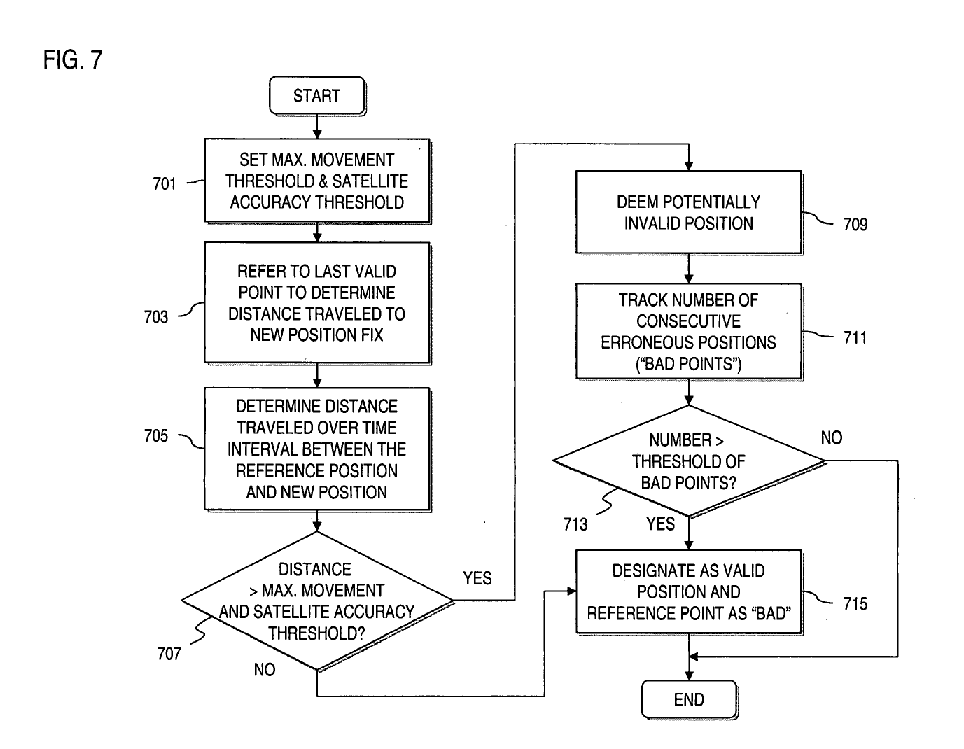

FIG. 7 is a flowchart of a process for erroneous position filtering, according to an embodiment of the present invention. The erroneous position filter is used to filter errant positions that occur when a sufficient number of satellites are being tracked (as with the excessive speed filter) or when GPS signal errors corrupt the position fix.

In step 701, the filter parameters, Maximum Movement Threshold and Satellite Accuracy Threshold, are set. The filter references the last valid point to determine the distance to the new position fix, per steps 703 and 705. If the distance traveled over the time interval between the reference and new position exceeds the Maximum Movement Threshold and the number of tracking satellites corresponding to the measurement is less than the specified Satellite Accuracy Threshold (as determined in step 707), the position is potentially invalid, as in step 709.

The number of consecutive erroneous positions (or “bad points”) are tracked, per step 711. If the number of consecutive erroneous positions exceeds the limit of bad points (as specified in the filter parameter Maximum Bad Position Count), the position may be deemed valid (steps 713 and 715). This special condition is used to recover from a bad reference point. Otherwise, if the number of consecutive erroneous positions is less than the Maximum Bad Position Count, the point remains invalid.

The filter processes, described in FIGS. 4, 6 and 7, advantageously provides improved data accuracy.

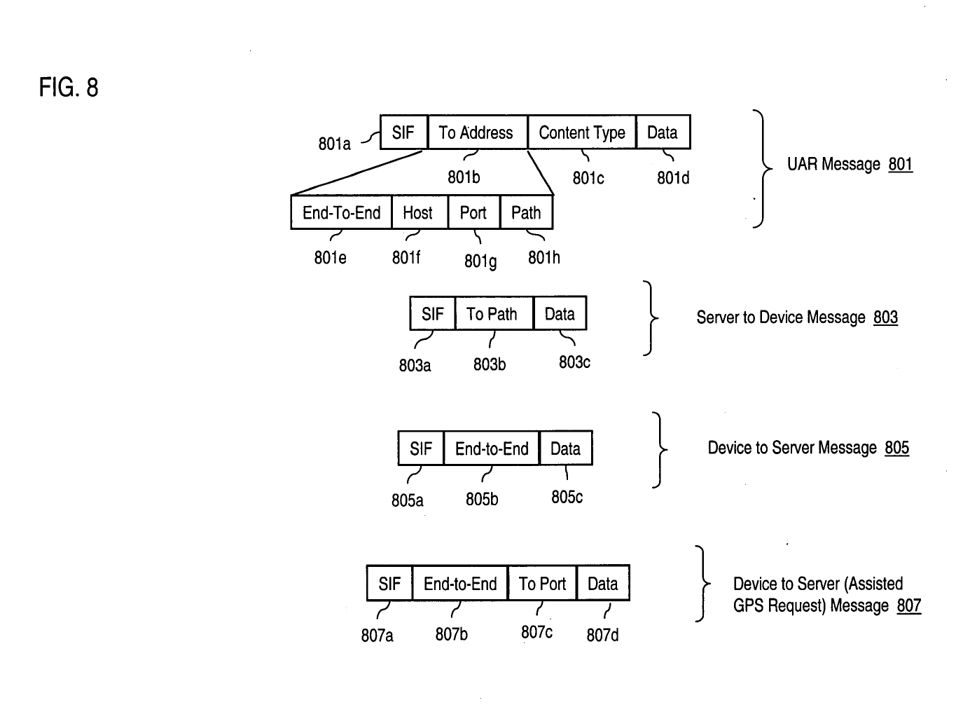

FIG. 8 shows a diagram of the formats of protocol messages used in the system of FIG. 1. By way of example, the protocol is the UAR protocol. Accordingly, a UAR message 801 includes the following fields: a Status Information Field (SIF) field 801a, a Destination Address (“To Address”) field 801b, a Content Type field 801c, and a Data field 801d. Table 2, below, defines these fields 801a-801c.

TABLE 2

| Field | Definition | Data Type | Size |
|---|---|---|---|
| SIF | Identifies the application protocol | Integer | 8 bits |
| | used to encode the remaining data in | | |
| | the message; indicates UAR | | |
| | addressing is used | | |
| To | Destination Address | UAR “To | Variable |
| Address | | Address” | |
| | | Encoding | |
| Content | Identifies the format of the attached | UAR | 24 bits |
| Type | Data | Content | |
| | | Type | |
| Data | UAR format data payload | UAR data | Variable |

With respect to the “To Address” field 801b, this address can be further specified the following fields: an End-To-End field 801e, a Host field 801f, a Port field 801g, and a Path field 801h. The End-To-End field 801e is utilized for device to server routing. It is noted that no addressing is needed for device to server routing with the exception of an Assisted GPS Request message. Because the routing server 305 controls message routing from the telemetry device 103, some of the address information requirement is specific to UAR. Path Addressing, per the Path field 801h, is used for server to device routing, as in the case, for example, addressing of a peripheral device attached to the telemetry device 103.

As shown in FIG. 8, for server to device messaging, message 803 can be used and includes a SIF field 803a, a To Address field 803b specifying the path, and a Data field 803c. A device to server message 805 utilizes a SIF field 805a, a To Address field 805b specifying the End-to-End address, and a Data field 805c. In the case of a device to server transmission relating to acquisition of Assisted GPS (e.g., in form of an Assisted GPS request), a message 807 is provided, and includes a SIF field 807a, a To Address field specifying the End-to-End address 807b and Port 807c, and a Data field 805c.

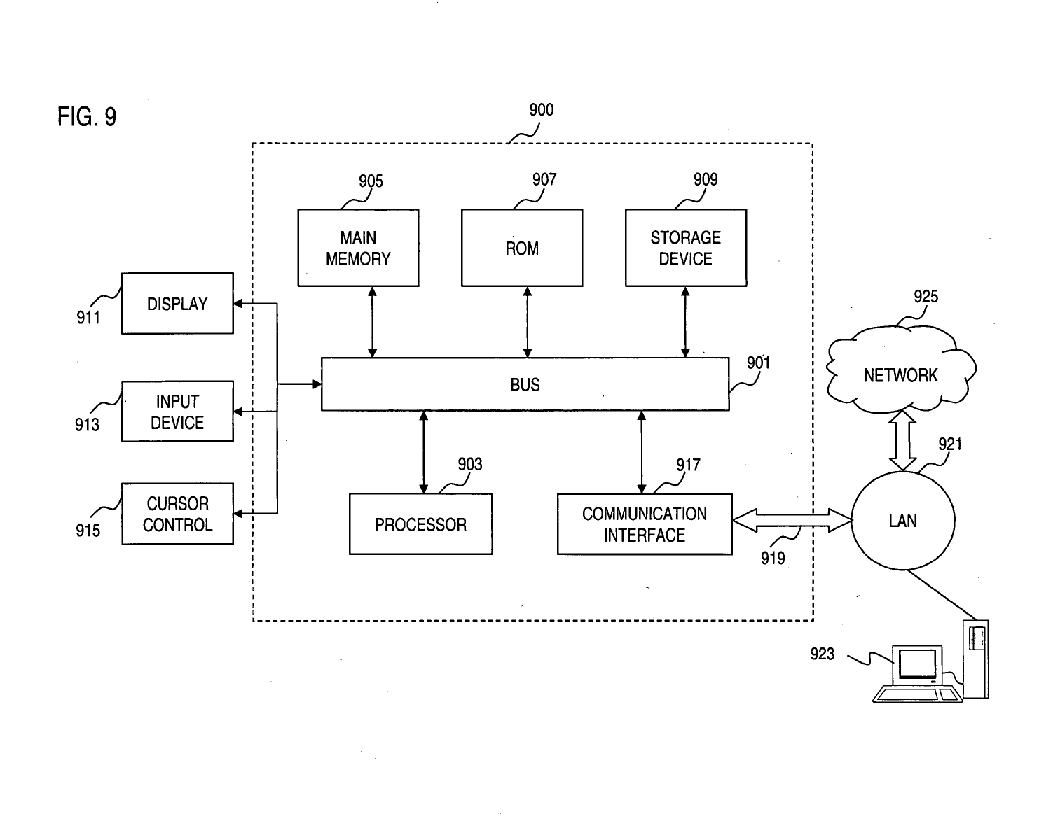

FIG. 9 illustrates a computer system 900 upon which an embodiment according to the present invention can be implemented. For example, the client and server processes for supporting fleet and asset management can be implemented using the computer system 900. The computer system 900 includes a bus 901 or other communication mechanism for communicating information and a processor 903 coupled to the bus 901 for processing information. The computer system 900 also includes main memory 905, such as a random access memory (RAM) or other dynamic storage device, coupled to the bus 901 for storing information and instructions to be executed by the processor 903. Main memory 905 can also be used for storing temporary variables or other intermediate information during execution of instructions by the processor 903. The computer system 900 may further include a read only memory (ROM) 907 or other static storage device coupled to the bus 901 for storing static information and instructions for the processor 903. A storage device 909, such as a magnetic disk or optical disk, is coupled to the bus 901 for persistently storing information and instructions.

The computer system 900 may be coupled via the bus 901 to a display 911, such as a cathode ray tube (CRT), liquid crystal display, active matrix display, or plasma display, for displaying information to a computer user. An input device 913, such as a keyboard including alphanumeric and other keys, is coupled to the bus 901 for communicating information and command selections to the processor 903. Another type of user input device is a cursor control 915, such as a mouse, a trackball, or cursor direction keys, for communicating direction information and command selections to the processor 903 and for controlling cursor movement on the display 911.

According to one embodiment of the invention, the filtering processes of the device data filtering logic 227 are performed by the computer system 900, in response to the processor 903 executing an arrangement of instructions contained in main memory 905. Such instructions can be read into main memory 905 from another computer-readable medium, such as the storage device 909. Execution of the arrangement of instructions contained in main memory 905 causes the processor 903 to perform the process steps described herein. One or more processors in a multi-processing arrangement may also be employed to execute the instructions contained in main memory 905. In alternative embodiments, hard-wired circuitry may be used in place of or in combination with software instructions to implement the embodiment of the present invention. Thus, embodiments of the present invention are not limited to any specific combination of hardware circuitry and software.

The computer system 900 also includes a communication interface 917 coupled to bus 901. The communication interface 917 provides a two-way data communication coupling to a network link 919 connected to a local network 921. For example, the communication interface 917 may be a digital subscriber line (DSL) card or modem, an integrated services digital network (ISDN) card, a cable modem, a telephone modem, or any other communication interface to provide a data communication connection to a corresponding type of communication line. As another example, communication interface 917 may be a local area network (LAN) card (e.g. for Ethernet™ or an Asynchronous Transfer Model (ATM) network) to provide a data communication connection to a compatible LAN. Wireless links can also be implemented. In any such implementation, communication interface 917 sends and receives electrical, electromagnetic, or optical signals that carry digital data streams representing various types of information. Further, the communication interface 917 can include peripheral interface devices, such as a Universal Serial Bus (USB) interface, a PCMCIA (Personal Computer Memory Card International Association) interface, etc. Although a single communication interface 917 is depicted in FIG. 9, multiple communication interfaces can also be employed.

The network link 919 typically provides data communication through one or more networks to other data devices. For example, the network link 919 may provide a connection through local network 921 to a host computer 923, which has connectivity to a network 925 (e.g. a wide area network (WAN) or the global packet data communication network now commonly referred to as the “Internet”) or to data equipment operated by a service provider. The local network 921 and the network 925 both use electrical, electromagnetic, or optical signals to convey information and instructions. The signals through the various networks and the signals on the network link 919 and through the communication interface 917, which communicate digital data with the computer system 900, are exemplary forms of carrier waves bearing the information and instructions.

The computer system 900 can send messages and receive data, including program code, through the network(s), the network link 919, and the communication interface 917. In the Internet example, a server (not shown) might transmit requested code belonging to an application program for implementing an embodiment of the present invention through the network 925, the local network 921 and the communication interface 917. The processor 903 may execute the transmitted code while being received and/or store the code in the storage device 909, or other non-volatile storage for later execution. In this manner, the computer system 900 may obtain application code in the form of a carrier wave.

The term “computer-readable medium” as used herein refers to any medium that participates in providing instructions to the processor 903 for execution. Such a medium may take many forms, including but not limited to non-volatile media, volatile media, and transmission media. Non-volatile media include, for example, optical or magnetic disks, such as the storage device 909. Volatile media include dynamic memory, such as main memory 905. Transmission media include coaxial cables, copper wire and fiber optics, including the wires that comprise the bus 901. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the present invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

While the present invention has been described in connection with a number of embodiments and implementations, the present invention is not so limited but covers various obvious modifications and equivalent arrangements, which fall within the purview of the appended claims.

1. A method for filtering telemetry data, the method comprising the steps of:
collecting data for monitoring of an asset;
receiving one or more filter parameters from a tracking system over a wireless network;
filtering the data according to the received filter parameters;
generating a message based on the filtered data; and
transmitting the message over the wireless network to the tracking system.

2. A method according to claim 1, wherein the filter parameters are selected based on status of a trigger corresponding to the asset.

3. A method according to claim 1, wherein the data includes position information and speed information, and the filter parameter includes a distance threshold, the method further comprising the step of:
determining whether a new position of the asset is within the distance threshold of a prior unfiltered position of the asset based on the position information; and
if the new position is within the distance threshold, declaring the new position to be identical to the prior unfiltered position and setting the speed information to zero.

4. A method according to claim 3, wherein the asset is coupled to a vehicle, and the filter parameter includes a second distance threshold, the method further comprising:
determining whether the vehicle is on or off,
wherein if the vehicle is off, the data is filtered according to the second distance threshold.

5. A method according to claim 1, wherein the asset is tracked using Global Positioning System (GPS) satellites, the asset selectively operating in an assisted GPS mode or an autonomous GPS mode.

6. A method according to claim 5, wherein the data includes speed information and position information, and the filter parameters include a maximum speed threshold and a satellite count threshold, the method further comprising the step of:
determining whether the maximum speed threshold is exceeded based on the speed information;
determining whether the number of available GPS satellites is below the satellite count threshold; and
declaring the speed information and the position information to be invalid if the maximum speed threshold is exceeded and the number of available GPS satellites is below the satellite count threshold.

7. A method according to claim 5, wherein the data includes position information, and the filter parameter includes a maximum movement threshold and a satellite count threshold, the method further comprising the step of:
determining distance traveled from a prior valid position based on the position information;
determining whether the number of available GPS satellites is below the satellite count threshold; and
declaring the position information to be invalid if the distance traveled exceeds the maximum movement threshold and the number of available GPS satellites is below the satellite count threshold.

8. A method according to claim 7, wherein the filter parameter further includes a maximum invalid count, the method further comprising the steps of:
tracking the number of consecutive invalid position information;
determining whether the number of consecutive invalid position information exceeds the maximum invalid count; and
if the maximum invalid count is exceeded, declaring a prior invalid position information to not be invalid.

9. A method according to claim 1, wherein the tracking system receives a configuration request message from a host over a data network, the configuration request message specifies the filter parameters.

10. An apparatus for supporting tracking of an asset, the apparatus comprising:
an input/output port coupled to the asset and configured to collect data for monitoring of the asset;
a transceiver configured to receive one or more filter parameters from a tracking system over a wireless network; and
a data filtering logic configured to filter the data according to the received filter parameters, wherein a message is generated based on the filtered data, and the transceiver transmitting the message over the wireless network to the tracking system.

11. An apparatus according to claim 10, wherein the filter parameters are selected based on status of a trigger corresponding to the asset.

12. An apparatus according to claim 10, wherein the data includes position information and speed information, and the filter parameter includes a distance threshold, the processor being further configured to determine whether a new position of the asset is within the distance threshold of a prior unfiltered position of the asset based on the position information, wherein if the new position is within the distance threshold, the processor declares the new position to be identical to the prior unfiltered position and sets the speed information to zero.

13. An apparatus according to claim 12, wherein the asset is coupled to a vehicle, and the filter parameter includes a second distance threshold, the processor being further configured to determine whether the vehicle is on or off, wherein if the vehicle is off, the data is filtered according to the second distance threshold.

14. An apparatus according to claim 10, wherein the asset is tracked using Global Positioning System (GPS) satellites, the asset selectively operating in an assisted GPS mode or an autonomous GPS mode.

15. An apparatus according to claim 14, wherein the data includes speed information and position information, and the filter parameters include a maximum speed threshold and a satellite count threshold, the processor being further configured to determine whether the maximum speed threshold is exceeded based on the speed information, and to determine whether the number of available GPS satellites is below the satellite count threshold, the processor declaring the speed information and the position information to be invalid if the maximum speed threshold is exceeded and the number of available GPS satellites is below the satellite count threshold.

16. An apparatus according to claim 14, wherein the data includes position information, and the filter parameter includes a maximum movement threshold and a satellite count threshold, the processor being further configured to determine distance traveled from a prior valid position based on the position information, and to determine whether the number of available GPS satellites is below the satellite count threshold, the processor declaring the position information to be invalid if the distance traveled exceeds the maximum movement threshold and the number of available GPS satellites is below the satellite count threshold.

17. An apparatus according to claim 16, wherein the filter parameter further includes a maximum invalid count, the processor being further configured to track the number of consecutive invalid position information and to determine whether the number of consecutive invalid position information exceeds the maximum invalid count, wherein if the maximum invalid count is exceeded, the processor declares a prior invalid position information to not be invalid.

18. An apparatus according to claim 10, wherein the communication interface is further configured to receive a configuration request message from a host over a data network, and the configuration request message specifies the filter parameter.

19. An apparatus for tracking an asset, the apparatus comprising:
means for receiving data including Global Positioning System (GPS) information corresponding to tracking of the asset coupled to a vehicle;
means for filtering the data to account for GPS signal errors associated with position and speed; and
means for transmitting the filtered data over a wireless network to a remote server.

20. A method according to claim 19, wherein the filter parameters are associated with status of an ignition of the vehicle.
